(19) United States
(12) Patent Application Publication
(10) Pub. No.: US 2018/0200768 A1
(43) Pub. Date: Jul. 19, 2018

(54) EQUIPMENT FOR AUTOMATIC SHEARING OF COLD-ROLLED VARIABLE THICKNESS PLATE, AND SHEARING METHOD BASED ON SAME

(71) Applicant: BAOSHAN IRON & STEEL CO., LTD., Shanghai (CN)

(72) Inventors: Fei Xiong, Shanghai (CN); Shanqing Li, Shanghai (CN); Zhenglian Jiang, Shanghai (CN)

(73) Assignee: BAOSHAN IRON & STEEL CO., LTD., Shanghai (CN)

(21) Appl. No.: 15/573,474

(22) PCT Filed: Mar. 29, 2016
(86) PCT No.: PCT/CN2016/077614

§ 371 Date: Mar. 19, 2018

(30) Foreign Application Priority Data
May 20, 2015 (CN) 201510259523.2

(51) Int. Cl. B21B 15/00; B23D 15/06; B23D 36/00

(52) U.S. Cl. CPC B21B 15/0007; B23D 36/0008; B23D 15/06

(57) ABSTRACT

Disclosed are an automatic shearing apparatus for a cold-rolled plate of variable thickness, and a shearing method using the apparatus. The method comprises that: a thickness gauge (4) and a length-measuring device (3) are successively arranged in front of shears (5); and a control device identifies the profile of a strip material passing through the thickness gauge (4) according to length tracing data and measured thickness values, and determines the position of the strip material at the shears (5), simultaneously compares the profile with the set profile of a plate of continuously variable thickness, and decides the action time of the shears. The apparatus and the method can efficiently and accurately shear rolls of supplied materials of continuously variable thickness into plates of continuously variable thickness which can be directly used by a user.

### TECHNICAL FIELD

The present invention is an automatic shearing method for a cold-rolled plate of variable thickness, which method can be used for automatic shearing of rolls of supplied materials of variable thickness according to a set shape.

### BACKGROUND ART

In order to achieve the goal of automobile lightweight, the current automobile industry is promoting the use of a strip material which continuously varies in thickness—a plate of variable thickness—obtained by rolling, as shown in FIG. 1. This type of plate of variable thickness can be rolled in a single sheet manner or roll manner, and rolling in a roll manner is more efficient, but has a positioning requirement for subsequent shearing.

In order to facilitate the rolling control, the set outlet thickness profile is periodic. Periodic changes in the thickness of the strip material cause the subsequent shearing to also have a certain regularity.

The existing cross shearing units all have a function of cutting to length, that is, the units can give plates of equal length by cutting to length in accordance with the data input by an operator. This function satisfies the shearing of rolls of equal thickness, but for strip materials with periodically varying thickness, only shearing in equal length is not possible to shear out a plate that meets the requirements. As shown in FIG. 2, position A is the required shearing point. If the position of the shears controlled by the shearing unit is at B, although the requirement for a sample piece of a length of L is also satisfied, the sheared sample plate is unusable. Therefore, during shearing, it is necessary to be able to identify and track the profile of the thickness of the strip material that needs to be sheared and to control the shears to fall at the set shearing position; and it is necessary to be able to identify whether the sheared sample plate meets the finished product requirements and to distinguish same during stacking.

Patent EP 0937521 A2 is a patent relating to straightening of a plate of continuously variable thickness. A control system triggers a straightening roller action according to the marking holes carried by supplied materials and used for marking the head and the tail of each period of profile. It can be seen that after the variable thickness rolling, the strip material will be marked at the head to tail position of each profile period. The patent is only directed to straightening of a plate of continuously variable thickness, and does not mention shearing.

Patent 201410828752.7 also mentions marking a strip material at an outlet of a roll gap and identifying the mark during shearing, but does not mention an implementation method for shearing.

### SUMMARY OF THE INVENTION

The invention proposes an automatic shearing method for a cold-rolled plate of variable thickness, which can efficiently and accurately shear rolls of supplied materials of continuously variable thickness into plates of continuously variable thickness which can be directly used by a user, as shown in FIG. 3.

In order to achieve the above object, the technical solutions of the present invention are as follows:

An automatic shearing apparatus for a cold-rolled plate of variable thickness is provided, which comprises: a control device, and a straightening device, a length-measuring device, a thickness gauge and shears arranged successively, wherein the length-measuring device, the thickness gauge and shears are controlled by the control device, and a strip material passes through the straightening device, is then successively subjected to a length measurement in the length-measuring device and a thickness measurement in the thickness gauge, and is then sheared by the shears.

A method for automatic shearing using the above-mentioned automatic shearing apparatus for a cold-rolled plate of variable thickness is provided, which is characterized by comprising the steps of:

the thickness gauge is arranged in front of the shears, and the length-measuring device is arranged in front of the thickness gauge; the control device identifies the profile of a strip material passing through the thickness gauge according to length tracing data and measured thickness values, and determines the position of the strip material at the shears, and simultaneously compares the profile with the set profile of a plate of continuously variable thickness, and decides the action time of the shears; and at the same time, the control device also determines whether the sheared plate is qualified, and determines whether the plate is stacked into a finished product stack or waste stack.

As a preferred solution, the automatic shearing apparatus for a cold-rolled plate of variable thickness further comprises a mark detector, which is arranged between the length-measuring device and the thickness gauge and is controlled by the control device.

A method for automatic shearing using the above-mentioned automatic shearing apparatus for a cold-rolled plate of variable thickness is provided, which is characterized by comprising the steps of:

the thickness gauge is arranged in front of the shears, and the length-measuring device is arranged in front of the thickness gauge, and a mark identification device is arranged behind the length-measuring device; a control system determines a shearing position according to a strip steel mark identified by the mark identification device, identifies the profile of a strip material passing through the thickness gauge according to length tracing data and measured thickness values, and determines the position of the strip material at the shears, and simultaneously compares the profile with the set profile of a plate of continuously variable thickness, and determines whether the strip steel meets dimensional accuracy, and decides the action time of the shears; and at the same time, the control device also determines whether the sheared plate is stacked into the finished product stack or the waste stack.

The beneficial effects of the invention mainly lie in that the apparatus and the method can efficiently and accurately shear rolls of supplied materials of continuously variable thickness into plates of continuously variable thickness which can be directly used by a user.

### BRIEF DESCRIPTION OF THE DRAWINGS

FIG. 1 is a schematic view of variable thickness rolling;

FIG. 2 is a schematic view of shearing position deviations;

FIG. 3 is a schematic view of setting a target profile for variable thickness rolling;

FIG. 4 is an automatic shearing method provided in embodiment 1;

FIG. 5 is an automatic shearing method provided in embodiment 1;

FIG. 6 is an arrangement view of a variable thickness rolling machine frame;

FIG. 7 is a schematic view of a rolled strip material;

FIG. 8 is a schematic view of a sample piece.

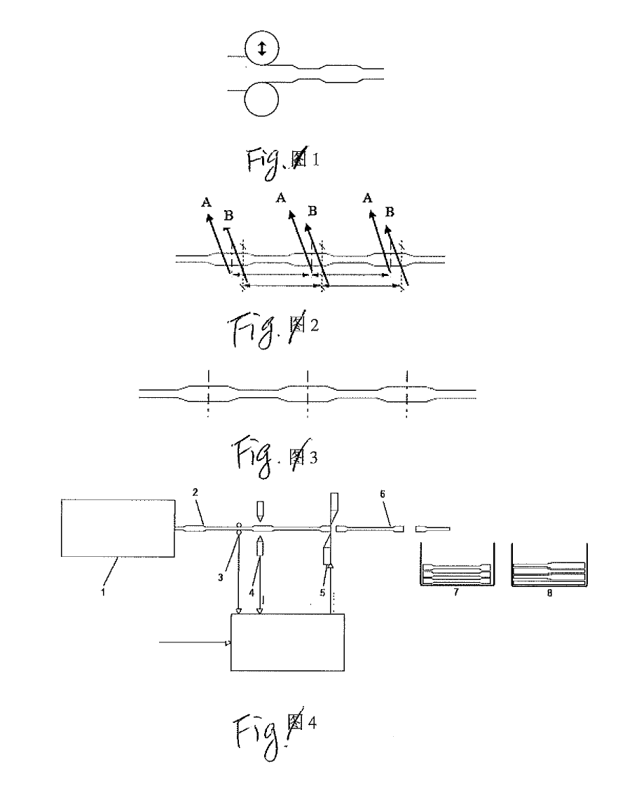

In the figures: 1. a straightening device; 2: a strip material; 3. a length-measuring device; 4. a thickness gauge; 5. shears; 6. a plate; 7. a finished stack; 8. a waste stack; 9. a mark identification device; 10. rollers; 12. a left recoiling machine; 12. a left thickness gauge; 13. a right recoiling machine; 14. a right thickness gauge; 15. a labeller; 16. a left velocimeter; and 17. a right velocimeter.

### DETAILED DESCRIPTION OF EMBODIMENTS

FIG. 2 shows the set rolled profile of a strip material that needs to be rolled. For the convenience of rolling mill control, the rolled profile is often set in a periodic form.

FIG. 6 is a schematic view of the arrangement of a rolling mill for achieving rolling. Marking equipment is arranged at an outlet of the roll gap of the rolling mill. The control system will make a mark O at the head to tail position of each set period according to the measurement result of the length-measuring device. The mark can be made using a mechanical, laser or color spraying method. 10. rollers; 11. a left recoiling machine; 12. a left thickness gauge; 13. a right recoiling machine; 14. a right thickness gauge; 15. a labeller; 16. a left velocimeter; and 17. a right velocimeter.

As shown in FIG. 7, the rolled strip material has a mark used for identification at the head to tail position of each set period.

### Embodiment 1

The structure of an automatic shearing apparatus for a cold-rolled plate of variable thickness provided in this embodiment is shown in FIG. 4, and includes: a control device, and a straightening device 1, a length-measuring device 3, a thickness gauge 4 and shears 5 arranged successively, wherein the length-measuring device 3, the thickness gauge 4 and the shears 5 are controlled by the control device.

A shearing method based on this embodiment comprises that: the thickness gauge 4 is arranged in front of the shears 5 and the length-measuring device 3 is arranged in front of the thickness gauge; and the control system identifies the profile of a strip material passing through the thickness gauge according to length tracing data and measured thickness values, and determines the position of the strip material at the shears. At the beginning of shearing, the head of the strip passes through the shears, and at this time, the size is often far from the set profile and therefore, the control system will control the action time of the shears according to the length of the waste materials to be sheared, and stack the sheared plate into the waste stack; and when the control system identifies that the profile of the strip material is coincident with the set profile, and the set shearing position has reached the shears, the control system will give a shearing command, and the sheared plate will be stacked into the finished stack.

### Embodiment 2

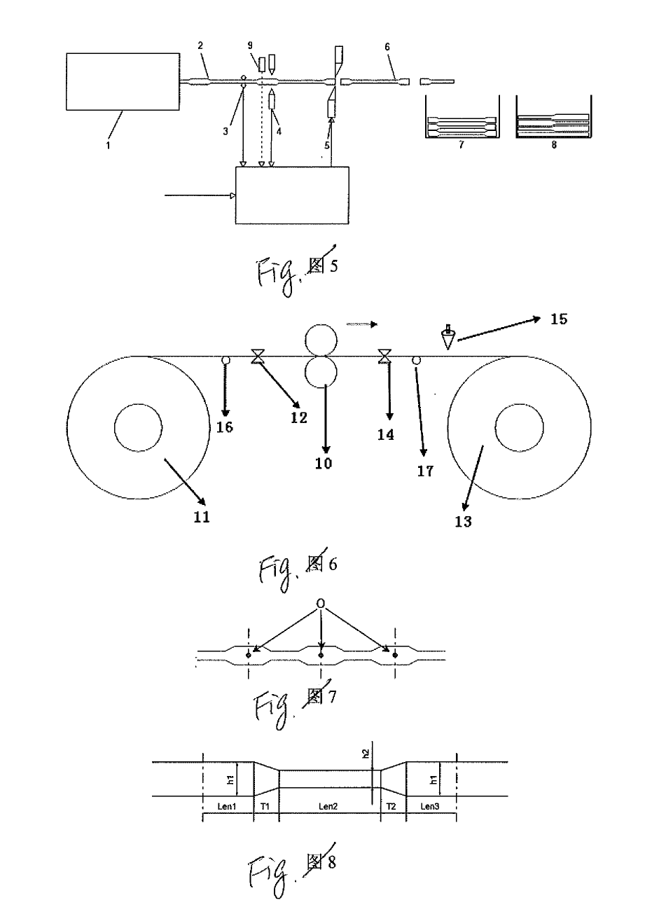

The structure of an automatic shearing apparatus for a cold-rolled plate of variable thickness provided in this embodiment is shown in FIG. 5, which differs from that of embodiment 1 in that: the automatic shearing apparatus for a cold-rolled plate of variable thickness further comprises a mark detector, which is arranged between the length-measuring device and the thickness gauge and is controlled by the control device.

The difference between this method and method 1 lies in making a determination using the mark made on the strip material 2 during rolling (as shown in FIG. 7). Therefore, the thickness gauge 4 is arranged in front of the shears 5, the length-measuring device 3 is arranged in front of the thickness gauge and a mark identification device 9 is arranged behind the length-measuring device. At the beginning of shearing, the head of the strip passes through the shears, the mark of a shearing point does not appear on the strip material 2 and the control system will control the action time of the shears according to the length of the waste materials to be sheared, and stack the sheared plate into the waste stack; when the mark of a shearing point appears on the strip material, the control system determines the shearing position according to the strip steel mark identified by the mark identification device 9, tracks same to the shearing position and controls the action of the shears, and at the same time, determines whether this piece of strip steel satisfies the dimensional accuracy according to length tracing data and measured thickness values, and determines whether the sheared plate 6 is stacked into the finished product stack or the waste stack.

### Application Example

A target profile for variable thickness rolling is set as follows—

thickness: h1=2.0 mm, h2=1.0 mm;

length: Len1=250 mm, T1=100 mm, Len2=500 mm, T2=100 mm, Len3=250 mm.

Two automatic shearing strategies are introduced below—

before a steel roll enters the shearing unit, the above profile setting data are input to the control system, and this is a sample piece containing three sections of equal thickness (a thickness of 2.0/1.0/2.0 mm, a length of 250/500/250 mm) and two transition sections (a length of 100/100 mm), so the length of a piece is:

After that, the following two solutions can be used for automatic shearing:

1) Method I

as shown in FIG. 4, the length-measuring device 3 and the thickness gauge 4 are arranged in front of the shears 5.

The control system measures a strip material that has been flattened and determines the profile of the strip material passing through the thickness gauge according to the length tracking data and measured thickness values (the key is to determine the positions of 1, 2, 3 and 4 inflection points in FIG. 8), and the position of the strip material at the shears, and at the same time, compares the profile with the input set profile and determines the action time of the shears.

The basic principle of shearing is that if it is measured that the above inflection points do not appear on the length of a piece, or if the above inflection point does not appear completely, the piece is sheared and stacked into the waste stack 8; otherwise, the thickness and length of each section are compared with the set quantitative values, and the sample pieces within an error range are stacked into the finished product stack 7, and the sample pieces outside the error range are stacked into the waste stack 8.

2) Method II

Referring to FIG. 5, the difference between this method and the method 1 lies in making a determination using the mark made on a strip steel during rolling (see FIG. 7). Therefore, the mark identification device 9, the length-measuring device 3 and the thickness gauge 4 are arranged in front of the shears 5, and the control system determines the shearing position according to a mark of the strip steel identified by the mark identification device 9.

This method is simpler and the control system controls the shears to fall at the mark position. At the same time, the control system also identifies the positions of 1, 2, 3, and 4 inflection points in FIG. 8, and the thickness and length of each section are compared with the set quantitative values, and the sample pieces within an error range are stacked into the finished product stack 7, and the sample pieces outside the error range are stacked into the waste stack 8.

Both of the above-mentioned methods use a special algorithm for identifying the inflection points.

In summary, the embodiments are only preferred embodiments of the present invention and are not intended to limit the implementation scope of the invention. Any equivalent variations and modifications made according to the shapes, constructions, characteristics and spirits in the scope of the claims of the invention should be included within the scope of the claims of the of the present invention.

1. An automatic shearing apparatus for a cold-rolled plate of variable thickness, characterized by comprising: a control device, and a straightening device, a length-measuring device, a thickness gauge and shears arranged successively, wherein the length-measuring device, the thickness gauge and shears are controlled by the control device, and a strip material passes through the straightening device, is then successively subjected to a length measurement in the length-measuring device and a thickness measurement in the thickness gauge, and is then sheared by the shears.

2. The automatic shearing apparatus for a cold-rolled plate of variable thickness of claim 1, characterized by further comprising a mark detector, which is arranged between the length-measuring device and the thickness gauge and is controlled by the control device.

3. A method for automatic shearing using the automatic shearing apparatus for a cold-rolled plate of variable thickness of claim 1, characterized by comprising the steps:
the thickness gauge is arranged in front of the shears, and the length-measuring device is arranged in front of the thickness gauge; the control device identifies the profile of a strip material passing through the thickness gauge according to length tracing data and measured thickness values, and determines the position of the strip material at the shears, and simultaneously compares the profile with the set profile of a plate of continuously variable thickness, and decides the action time of the shears; and at the same time, the control device also determines whether the sheared plate is qualified, and determines whether the plate is stacked into a finished product stack or waste stack.

4. A method for automatic shearing using the automatic shearing apparatus for a cold-rolled plate of variable thickness of claim 2, characterized by comprising the steps:
the thickness gauge is arranged in front of the shears, and the length-measuring device is arranged in front of the thickness gauge, and a mark identification device is arranged behind the length-measuring device; a control system determines a shearing position according to a strip steel mark identified by the mark identification device, identifies the profile of a strip material passing through the thickness gauge according to length tracing data and measured thickness values, and determines the position of the strip material at the shears, and simultaneously compares the profile with the set profile of a plate of continuously variable thickness, and determines whether the strip steel meets dimensional accuracy, and decides the action time of the shears; and at the same time, the control device also determines whether the sheared plate is stacked into the finished product stack or the waste stack.
